(19) United States
(12) Patent Application Publication
(10) Pub. No.: US 2023/0303885 A1
(43) Pub. Date: Sep. 28, 2023

(54) RUBBER INK FORMULATIONS FOR DIRECT INK WRITING PROCESS

(71) Applicants: Jae-Won Choi, Copley Township, OH (US); Sarath Suresh Kamath, Akron, OH (US); Myoeum Kim, Charlottesville, VA (US)

(72) Inventors: Jae-Won Choi, Copley Township, OH (US); Sarath Suresh Kamath, Akron, OH (US); Myoeum Kim, Charlottesville, VA (US)

(21) Appl. No.: 18/188,784

(22) Filed: Mar. 23, 2023

Related U.S. Application Data
(60) Provisional application No. 63/323,694, filed on Mar. 25, 2022.
(60) Provisional application No. 63/425,693, filed on Nov. 16, 2022.

(51) Int. Cl. C09D 107/02; C09D 109/08; C09D 127/12; B60C 1/00; B60C 11/00; B33Y 70/00; B29C 64/314; B33Y 80/00; B29D 30/06; B29C 64/118; B29C 64/30; B33Y 40/20; B33Y 40/10

(52) U.S. Cl. CPC C09D 107/02; C09D 109/08; C09D 127/12; B60C 1/0016; B60C 11/0008; B33Y 70/00; B29C 64/314; B33Y 80/00; B29D 30/0681; B29C 64/118; B29C 64/30; B33Y 40/20; B33Y 40/10; B29L 2030/002

(57) ABSTRACT

A composition for a direct ink writing includes a polymeric component in latex form, where the latex includes greater than 75% solids content; and additives adapted to provide the composition with capability of being utilized as a rubber ink formulation for the direct ink writing process. A method of producing an additive manufacturing product includes steps of providing an initial polymeric component in latex form, where the initial polymeric component in latex form includes from about 50% to about 70% solids content; removing water from the initial polymeric component in latex form to thereby form a subsequent polymeric component in latex form, where the subsequent polymeric component in latex form has greater than 75% solids content; and mixing the subsequent polymeric component in latex form with additives adapted to provide a rubber ink formulation composition; and additive manufacturing the rubber ink formulation composition to thereby form a green component.

### CROSS-REFERENCE TO RELATED APPLICATIONS

This application claims the benefit of U.S. Provisional Application No. 63/323,694, filed on Mar. 25, 2022, and U.S. Provisional Application No. 63/425,693, filed on Nov. 16, 2022, which are incorporated herein by reference.

### FIELD OF THE INVENTION

One or more embodiments of the present invention relate to rubber ink formulations which can be used with a 3D printing process, such as direct ink writing. One or more embodiments of the present invention relate to sensors made from the printed materials.

### BACKGROUND OF THE INVENTION

Additive manufacturing (AM), also called 3D printing, was introduced in the 1980's and has been used for products in a variety of industries, including aerospace, automotive, and architectural applications. AM allows for customized manufacturing without a mold and does not require expensive tools. An exemplary AM process is direct ink writing (DIW), which may also be known as direct-print (DP) and direct-write (DW).

Natural rubber, which is mainly composed of poly-cis-isoprene and is produced by the rubber tree (Hevea brasiliensis), has been used for many applications in the automotive industry because it provides a broad range of physical and chemical properties. The performance of natural rubber can be limited in terms of thermal stability, chemical resistance, and oil resistance, efforts have included the creation of synthetic rubbers, such as styrene-butadiene rubber (SBR).

Natural rubber and synthetic rubber can be provided in latex form. Inkjet printing of latex is known to have several drawbacks. One drawback of particular note is nozzle clogging from agglomeration, which could result from efforts to control the viscosity of the material to facilitate use for printing. Shrinkage of the material upon printing or curing is also a concern.

Rubber parts, such as certain parts used in vehicles, allow for continuous loading and unloading conditions based on the ability of rubber to deform and restore the original shape. However, these fatigue conditions can result in permanent altering of the microstructures of rubber, which can lead to tears, cracks, and other damage. It is therefore important to monitor these rubber parts for detecting permanent rubber deformation.

There remains a desire for improved compositions for additive manufacturing, and corresponding improvements in methods and products.

### SUMMARY OF THE INVENTION

A first embodiment provides a composition for a direct ink writing process, the composition including a polymeric component in latex form, where the latex includes greater than 75% solids content; and additives adapted to provide the composition with capability of being utilized as a rubber ink formulation for the direct ink writing process.

Another embodiment provides a method of producing an additive manufacturing product, the method including steps of providing an initial polymeric component in latex form, where the initial polymeric component in latex form includes from about 50% to about 70% solids content; removing water from the initial polymeric component in latex form to thereby form a subsequent polymeric component in latex form, where the subsequent polymeric component in latex form has greater than 75% solids content; and mixing the subsequent polymeric component in latex form with additives adapted to provide a rubber ink formulation composition; and additive manufacturing the rubber ink formulation composition to thereby form a green component.

### DETAILED DESCRIPTION OF ILLUSTRATIVE EMBODIMENTS

Advantages of the present invention will become better understood with regard to the following description, appended claims, and accompanying drawings wherein:

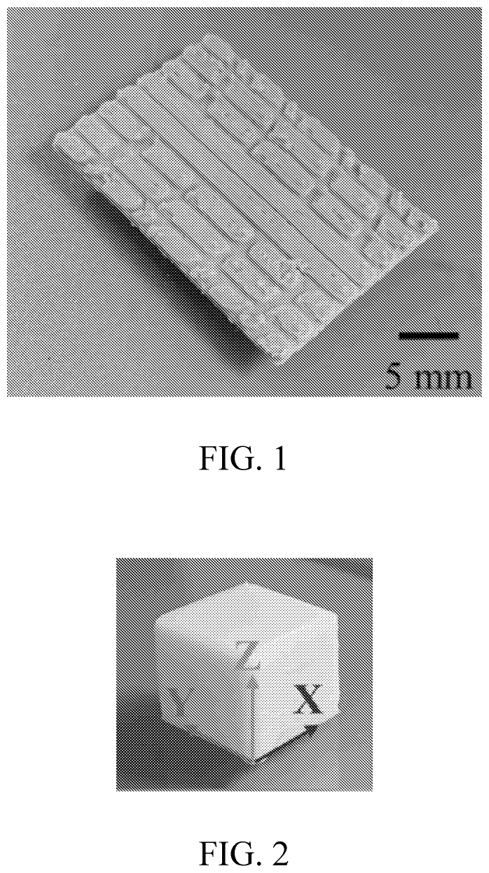

FIG. 1 is a photo of a partial tire tread representation made according to one or more embodiments of the present invention;

FIG. 2 is a photo of a dimensional accuracy cube specimen made according to one or more embodiments of the present invention;

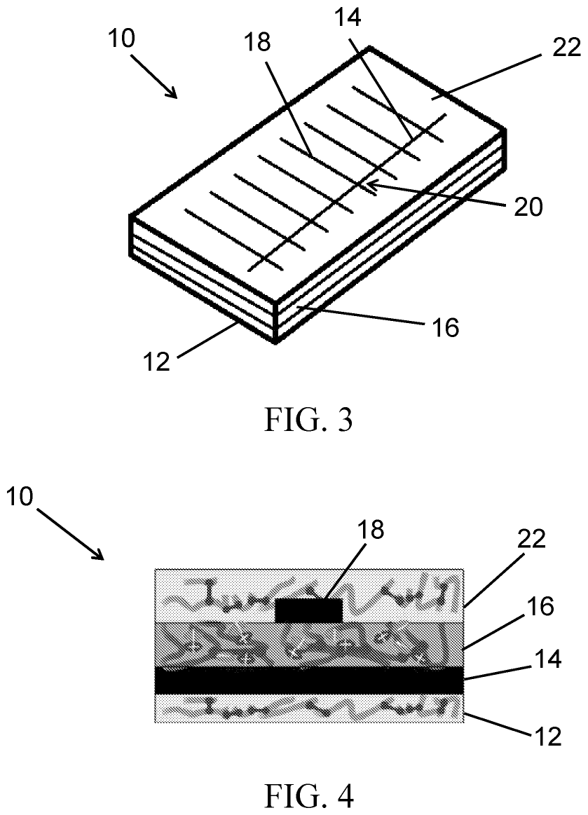

FIG. 3 is a perspective view of a sensor according to one or more embodiments of the present invention;

FIG. 4 is a sectional view of a sensor according to one or more embodiments of the present invention; and

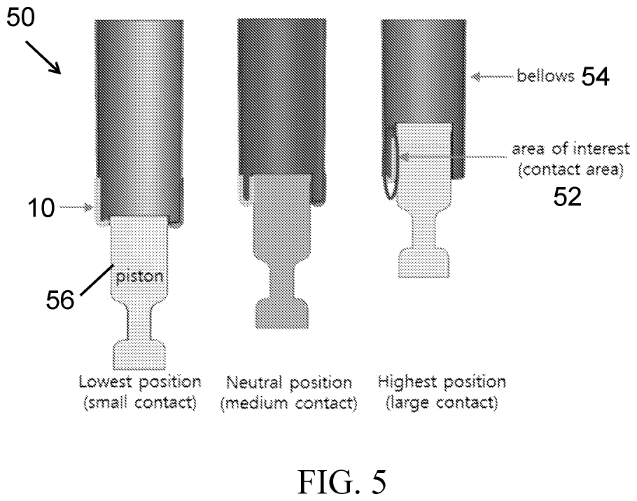

FIG. 5 is a schematic of a sensor within a piston and bellows assembly according to one or more embodiments of the present invention.

### DETAILED DESCRIPTION OF ILLUSTRATIVE EMBODIMENTS

One or more embodiments of the present invention relate to rubber ink formulations. Advantageously, the rubber ink formulations can be used with a 3D printing process, such as direct ink writing. The rubber ink formulations include a polymeric component, which may be one or more of a natural polymer and synthetic polymer, including combinations thereof. The polymeric component may be provided in latex form, which latex may be increased in solids content prior to combination with other components to form a rubber ink formulation. That is, the rubber ink formulation should have a relatively high solids content. In addition to the polymeric component, the rubber ink formulations can have one or more additives, which may be utilized based on a desired end product. As suggested above, the rubber ink formulations can include both natural rubber and a synthetic rubber, which may be referred to as a liquid rubber. Other embodiments of a rubber ink formulation include a fluoroelastomer as a synthetic rubber, which fluoroelastomer may be a terpolymer latex. One or more embodiments of the present invention relate to the printed material made from the rubber ink formulations. Exemplary printed materials include tires, tire components, and sensors. Advantageously, one or more embodiments provide a sensor which can be used for detecting deformation of a rubber part, such as a bellows utilized with a piston.

Further aspects of the rubber ink formulations are now disclosed.

One or more embodiments of the present invention include a rubber ink formulation including natural rubber as a polymeric component. The natural rubber may be in the form of natural rubber latex, which has about 50-60% solid contents. Natural rubber latex (NL) can be composed of about 45% cis-isoprene, about 5% non-rubber content (such as carbohydrates and protein), and about 50% water by weight. Raw natural rubber is classified as a polymer, and generally includes four different isomers of polyisoprenes.

The loss of weight and the physical properties of the resulting materials should be considered when processing natural rubber latex due to the presence of water. Therefore, one or more embodiments of the present invention can utilize various processing methods (e.g., manufacturing processes and pre-treatments) and/or additives (e.g., synthetic rubber) for enhancing the dimensional accuracy of a resulting part or component made from a rubber ink formulation including natural rubber latex.

One or more embodiments of the present invention include a rubber ink formulation including synthetic rubber as a polymeric component. Where a rubber ink formulation also includes natural rubber latex, a synthetic rubber may be utilized as an additive. In other embodiments, synthetic rubber may be used as the sole polymeric component or rubber component for a rubber ink formulation.

Where a rubber ink formulation includes both natural rubber latex and a synthetic rubber, the natural rubber latex may serve as a matrix in which a liquid synthetic rubber and additives are dispersed. Where a rubber ink formulation includes only synthetic rubber, the synthetic rubber latex may serve as a matrix in which additives are dispersed. The synthetic rubber may be in the form of a liquid synthetic rubber, which can be a single component (e.g., only liquid styrene-butadiene rubber (L-SBR)) or can be two or more different components (e.g., liquid styrene-butadiene rubber and liquid butadiene rubber (L-BR)).

Exemplary synthetic rubbers or liquid rubbers include butadiene rubber, isoprene rubber, styrene-butadiene rubber, butadiene copolymers, isoprene copolymer, silicon rubber, neoprene, nitrile type rubber, urethane rubber, chlorinated rubber, butyl rubber, acrylic rubber, fluoro rubber, isocyanate rubber, and combinations thereof. Other suitable synthetic rubbers may be generally known to the skilled person.

One or more embodiments of the present invention include a rubber ink formulation including a fluorocarbon-based synthetic rubber as a polymeric component, which may be referred to as a fluoroelastomer. The fluorocarbon-based synthetic rubber can be a fluoroelastomer (FKM), a perfluoro-elastomer (FFKM), a tetrafluoro ethylene/propylene rubber (FEPM), or combinations thereof. The fluoroelastomer can be a terpolymer. The fluoroelastomer may be in the form of latex, which can have about 60-70% solids content. The fluoroelastomer can have a fluorine content of about 68%, and in other embodiments, about 60-70%. An exemplary fluoroelastomer is Tecnoflon® TN Latex available from Solvay.

The solids contents provided above generally refer to the solid content of these materials as they are initially obtained, which may be referred to as an initial polymeric component. One or more embodiments may include increasing the solids content of a polymeric component before forming a rubber ink formulation. Said another way, a polymeric component (e.g., natural rubber latex) may undergo a step of increasing solids content.

Increasing the solids content may be achieved by centrifugation. The centrifugation may include multiple passes of centrifugation, which may be from 2 to 10 separate centrifugation steps.

In these or other embodiments, increasing the solids content of a polymeric component may be obtained by incorporating synthetic liquid rubber into a latex matrix. That is, increasing the amount of synthetic liquid rubber within a latex matrix will generally serve to increase the overall solid content of the combined mixture of the matrix and the synthetic liquid rubber.

Increasing the solids content of a polymeric component, which may be referred to as a subsequent polymeric component or a second polymeric component, may be up to about 70% solids content, in other embodiments, up to about 75% solids content, in other embodiments, up to about 80% solids content, in other embodiments, up to about 85% solids content, in other embodiments, up to about 87% solids content, in other embodiments, up to about 89% solids content, and in other embodiments, up to about 90% solids content. These solids contents may also refer to the solids content of a rubber ink formulation. These solids contents may also refer to the solids content being greater than these amounts. The other additives may add some additional solids, though this will generally be a relatively small amount.

With the relatively high solids content, the polymeric component and rubber ink formulation will have relatively high viscosity, which relatively high viscosity will generally enable the additives to diffuse uniformly and to enable building a 3D structure through additive manufacturing techniques.

In one or more embodiments, increasing the solids content of a polymeric component may be obtained by removing solvent other than water. Removing solvent other than water may be done by centrifugation. In one or more embodiments, a polymeric component may be devoid of solvent other than water. In other embodiments, a polymeric component includes less than 1 wt. % solvent other than water, and in other embodiments, less than 0.5 wt. 30% solvent other than water, relative to an overall composition of the polymeric component.

As suggested above, the polymeric component may include two different components, which may include a matrix component with a liquid synthetic rubber dispersed therein. The weight ratio of the matrix component to the liquid synthetic rubber component may be about 5:1, in other embodiments, about 5:2, in other embodiments, about 5:3, and in other embodiments, about 3:2. The weight ratio of the matrix component to the liquid synthetic rubber component may be greater than 5:1, and in other embodiments, greater than 5:2. These ratios, as with other values disclosed herein, may be utilized to form suitable ranges.

In addition to a synthetic liquid rubber, the rubber ink formulation can include a variety of other additives. The additives utilized can be based on the particular polymeric component utilized and/or on the desired end product. For example, where a desired end product is to be vulcanized, the additives can include commonly known vulcanization additives. The skilled person will generally understand the appropriate additives and amounts thereof, though additional details are provided herein.

Exemplary additives include surfactants, fillers, curatives, activators, accelerators, antioxidants, antiozonants, inhibitors, other processing aids (e.g., oil), and pigments.

Exemplary surfactants include Triton™ X-100, n-dodecyl β-d-maltoside, digitin, polyoxyethylenesorbitan monolaurate, polyoxyethylenesorbitan monooleate, sorbitan monolaurate, 1,2,3-Tri(cis-9-octadecenoyl) glycerol, polysorbatum 20, sorbitan trioleate, ascorbic acid 2-glucoside, and sorbitan sesquioleate. The surfactant may be present in an amount up to 5 parts per hundred parts rubber (phr), such as about 2 phr.

Exemplary additives include bis(2-benzothiazole) disulfide (MBTS), 2-mercaptobenzothiazole (MBT), zinc salt of mercaptobenzothiazole (ZMBT), tetramethyl thiuram monosulfide (TMTM), dipentamethylene thiuram tetrasulfide (DPTT), diphenyl quinidine(DPG), diorthotolyl guanidine (DOTG), xanthate (NaIX), ethylene thiourea (ETU), dipentamethylene thiourea (DPTU), dibutyl thiourea (DBTU), Guanidine, Dithocarbamate, Thiurea, isopropylxanthate, N-oxydiethylene-N′-oxydiethylenethiocarbamylsulfonamide (OTOS), 2-Morpholinodithiobenzothiazole (MBSS), Dithiomorpholine (DTDM), Caprolactam disulfide (CLD), Alkyl phenol disulfide, N-Cyclohexylbenzothiazole-2-sulfenamide (CBS), N-tert-butylbenzothiazole-2-sulfenamide (TBBS), Zinc dimethyldithiocarbamate (ZDMC), and Dicyclohexyl-2-benzothiazolesulfenamide (DCBS).

An exemplary inhibitor is N-(cyclohexylthio) phthalimide (CTP).

Exemplary activators include stearic acid and zinc oxide. The activators may be present in an amount of from about 2 phr to about 10 phr, such as about 5 phr, which may be about 4 phr zinc oxide and about 1 phr stearic acid.

Exemplary curatives, which may also be referred to as vulcanization agents, include sulfur and peroxide. An exemplary amount of sulfur is about 2 phr.

Exemplary accelerators include triethylenetetramine (TETA), tetrarnethylthiuram disulfide (TMTD), and n-cyclohexyl-2-benzothioazole sulfenamide (CBTS). The accelerators may be present in an amount of from about 0.5 phr to about 5 phr.

An exemplary pigment is chromium oxide. The pigment may be present in an amount of from about 2 phr to about 5 phr.

Exemplary fillers include reinforcing and non-reinforcing fillers. Exemplary fillers include carbon black, carbon nanotubes, silica, networked silica, fumed silica, calcium carbonate, kaolin clay, precipitated silica, talc, barite, wollastonite, mica, precipitated silicates, fumed silica, and diatomite. The filler and other additives can be used to control rheologic al properties for the success of 3D printing and properties (e.g., mechanical, thermal, chemical) for a desired application of an end product.

Though aspects of various methods are disclosed above, further details of methods are provided here. Methods can include a method of making the rubber ink formulation, a method of 3D printing, and a method of making an end product.

As discussed above, a method of making the rubber ink formulation generally includes first providing or forming the polymeric component. As discussed above, this can include increasing the solids content thereof, such as by centrifugation. A method of making the rubber ink formulation may further include filtering the polymeric component latex through a filter to remove agglomerated particles. An exemplary filter has a mesh pore size of from about 50 μm to about 200 μm, in other embodiments, about 100 μm. The polymeric component can then be blended with liquid rubber according to the above ratios, which may be for providing better mechanical properties and printing properties. The other additives can then be combined under suitable mixing conditions to form the rubber ink formulation. A second filtering step may then be utilized.

Suitable details for an additive manufacturing process will generally be known to the skilled person. This may include utilizing direct ink writing (DIW), which is an extrusion-based additive manufacturing method. In direct ink writing, a liquid-phase composition, which may be referred to as an ink or a rubber ink formulation, is dispensed out of relatively small nozzles. The dispensing is generally under controlled flow rates and deposited along digitally defined paths to fabricate a 3D printed structure in a layer-by-layer manner.

An additive manufacturing process may include utilizing a Direct Print Photopolymerization (DPP) machine. This setup can include high-resolution XYZ linear stages. Manual translation stages can be attached to an extruder barrel, which may be a syringe, and connected to the Z-stage. Extrusion through the syringe can be obtained by integrating a pneumatic pump. The XYZ linear stages and a pressure controller can be synchronized using G-code instructions, which can be interfaced with LabVIEW software.

A 3D model can be designed using CAD software (e.g., SolidWorks) to print using the DPP machine. The design can be translated as a stereolithography (STL) file. A host software can convert the STL file into layers and generate the G-code, which contains the toolpath and extrusion parameter for 3D printing. The layer thickness can be adjusted based on the tip size, which may be about 250 μm. Infill density and raster angle can be adjusted appropriately.

The rubber ink formulation can be loaded into the syringe barrel immediately after preparing to prevent drying. This may include remixing the formulation to remove air bubbles in the material. Next, the syringe can be placed on the XYZ stage and connected to the pneumatic pump to perform the 3D print. Various pressures and speed ranges can be utilized. Exemplary pressure ranges include from about 20 psi to about 90 psi, in other embodiments about 20 psi to about 45 psi, and in other embodiments from about 65 psi to about 90 psi. The speed can range from about 5 mm/s to about 30 mm/s, in other embodiments from about 2 mm/s to about 50 mm/s, and in other embodiments down to about 1 mm/s. A thermal energy source (e.g., infrared laser) can be used to expedite the curing process during the printing. The additive manufacturing apparatus produces a green component.

The green component can then be subjected to suitable vulcanization or curing conditions in order to produce an end product, which may be referred to as a vulcanizate or vulcanized component. Details relative to suitable vulcanization or curing conditions will be generally known to the skilled person. Exemplary vulcanization conditions include thermal treatment of the green component at about 160° C. for about 20 minutes.

The materials disclosed herein may be utilized for a variety of end products. Exemplary end products include tires, tire components (e.g., tire tread), and sensors. Exemplary sensors may be disclosed in U.S. Pat. Nos. 9,664,717; 10,156,487; and 11,366,030; which are incorporated herein by reference for this purpose. Other exemplary materials include pressure-sensitive sensors and flexible/stretchable electrodes for testing load, pressure, temperature, force, deformation, and vibration at relatively high temperature (e.g., above 200° C.). Other exemplary materials include long-lasting, durable rubber components which are used at high temperatures (e.g., rubber components utilized in engines or engine rooms).

With reference to FIGS. 3-5, one or more embodiments of the present invention include a sensor 10, which may also be referred to as a tactile sensor 10. As seen in FIGS. 3 and 4, sensor 10 will include a variety of layers.

A first insulating layer 12 can be formed, which can be by casting a composition into a mold and then UV curing. The composition for first layer 12 should include insulating material, which may be referred to as a base polymer matrix or a main matrix. The main matrixes should be a printable elastomeric material which has good durability and temperature resistance while maintaining good flexibility. Various combinations of (meth)acrylate monomers and oligomers can be used whose properties such as hardness, tensile strength, elongation at break, toughness, and temperature resistance are similar to the material properties of a rubber bellows 54 (FIG. 5). Crosslinkers can be used to tune mechanical properties, primarily the hardness required for elastomers. Photoinitiators and thermal initiators can be used for crosslinking. Examples of photoinitiators include 2,2-dimethoxy-2-phenylacetophenone and benzoin ethyl ether. An example of a thermal initiator is 2,2′-azobis(2-methyl propionamidine) dihydrochloride. Fumed silica can be added for shear-thinning properties and better 3D pressure-sensitive material and conductive materials.

A first electrode 14 can then be printed on first layer 12, which can be by a screen printing technique and then thermal curing. First electrode 14 can be made from a printable and conductive material including nanoparticles such as nanotubes (e.g., multi-walled carbon nanotubes (MWNT)), silver nanowires, or similar components. These nanoparticles can be dispersed in a prepolymer matrix. The concentration of the nano-particles can be from about 0.5 wt. % to about 20 wt. %. The combination of photoinitiators and thermal initiators disclosed above can be used for crosslinking.

A pressure-sensitive layer 16 can then be formed on first electrode 14, which can be by pouring a composition into the mold and then UV curing. Pressure-sensitive layer 16 can be made from an ionic liquid (IL) which is blended with the composition disclosed above for the base material (i.e., for layer 12). The concentration of the ionic liquid can be from about 0.1 wt. % to about 20 wt. %. Examples of ionic liquids include 1-Ethyl-3-methylimidazolium tetrafluoroborate (EMIBF4, Tg of −95.15° C.) and 1-Ethyl-3-methylimidazolium bis(trifluoromethylsulfonyl)imide (EMITFSI, Tg of −98.15° C.). Pressure-sensitive layer 16 generally works by the pumping of ions from the polymer network due to pressure-induced breakage of hydrogen bonds, which results in ion polarization.

A second electrode 18 can then be printed on pressure-sensitive layer 16, which can be by a screen printing technique and then thermal curing. Second electrode 18 can have a similar composition as disclosed above for first electrode 14. Second electrode 18 can be printed in a perpendicular manner relative to first electrode 14. The overlaps of first electrode 14 and second electrode 18 form taxels 20.

A second insulating layer 22 can then be formed, which can be by casting a composition into a mold and then UV curing. The composition for second insulating layer 22 can have a similar composition as disclosed above for first layer 12.

Sensor 10 can be used for monitoring within an assembly 50 (FIG. 5). Sensor 10 would be positioned in an area 52 between rubber bellows 54 and a piston 56 or other moving component. As shown in FIG. 5, bellows 54 and sensor 10 will be folded depending on the displacement of piston 56. The size (e.g., length, depth, and thickness) of sensor 10, and the number and spacing of taxels 20 can be designed based on the size of bellows 54.

In one or more embodiments, sensor 10 is made and then adhered to bellows 54. Prepared sensors 10 can be attached using an industrial rubber adhesive. In one or more embodiments, the entire sensor 10 can be coated with a rubber adhesive for durability. An example of a rubber adhesive is a cyanoacrylate-based adhesive.

In one or more embodiments, sensor 10 can be directly printed on a surface of bellows 54.

A method of operating sensor 10 and assembly 50 is now described. A fabricated tactile sensor 10 is installed in rubber bellows 54 with sensor 10 including several taxels 20. Upon movement of piston 56, some taxels 20 are in contact with piston 56 and some taxels 20 are not. Individual taxels 20 detect signals and processing of these signals can indicate properties, such as the displacement of piston 56, how fast the piston 56 moves, how much pressure is inside the bellows 54, temperature of the bellows 54, vibration of the bellows 54, and malfunction. This information can be used to gauge the health of the rubber bellows 54, where deformed, distorted, and torn bellows result in different signals. Deformation can be generated together with temperature changes, which may generate coupled signals. As an ion conductivity increases due to the temperature rise, the baseline of signals is expected to increase, where the amplitude of the signal represents the deformation of the smart elastomer. The effects of temperature and force can be coupled, and this can be decoupled by signal processing, where the baseline tells the temperature effects, and the amplitude of a signal measured from the baseline tells the force effect. Said another way, tactile sensors 10 are sensitive to both force (or pressure) and temperature, which can be coupled in signals but can be decoupled by signal processing.

### EXAMPLES

### Example 1

In one example, natural rubber latex (NL) was purchased from Liquid Latex Direct (Burton-upon-Stather, UK), while liquid butadiene rubber (which was based on an acrylate oligomer) was obtained from Kuraray Company, Ltd (Tokyo, Japan). TritonX-100 surfactant and stearic acid activator were purchased from Sigma-Aldrich (St. Louis, USA). The vulcanizing agents and accelerators used in this study—sulfur, zinc oxide, tetramethylthiuram disulfide (TMTD), and Ncyclohexyl-2-benzothioazole sulfenamide (CBTS)—were provided by Akrochem Corp (Akron, USA).

Thermogravimetric analysis (TGA) was used to measure the thermal decomposition behavior of the NL and characterize the amount of natural rubber solids in the raw latex. In this analysis, which was conducted using a TA Instruments Q500 thermogravimetric analyzer, natural rubber latex samples were heated from 25° C. to 600° C. at a scanning rate of 10° C./min in a nitrogen atmosphere. The analysis showed the initial solid content of the raw NL to be approximately 60%. In an effort to increase the amount of solids in the latex (so as to enhance the dimensional accuracy of components printed with NL by reducing shrinkage due to the evaporation of non-solid content), the amount of water was reduced. To accomplish this, the raw NL was centrifuged using an Allegra X-30R series centrifugal separator from Beckman Coulter, Inc., and the latex was collected from the surface of the water; this process was repeated two times. The collected latex was then blended at 2500 rpm for 30 s in a FlackTek SpeedMixer™ high speed mixer. Thermogravimetric analysis revealed that the centrifuged natural latex had a solid content of approximately 80%, which was deemed to be sufficient.

Before using the natural latex in the preparation of rubber inks, the centrifuged NL was first filtered through a nylon net filter with a 100-μm pore mesh (Sigma-Aldrich) to remove any agglomerated particles. A portion of the centrifuged and filtered NL was kept aside for printing and was designated as a base matrix for ink BN-0. To a container that contained the remaining filtered natural latex, liquid synthetic butadiene rubber (liquid rubber) was added to obtain mixtures having different ratios of NL to synthetic rubber (5:1, 5:2 and 5:3, which were designated as base matrices for inks BN-1, BN-2, and BN-3, respectively). Next, in order to prepare the final rubber inks called as BN-0, BN-1, BN-2, and BN-3, 2 parts per hundred rubber (phr) of Triton™ X-100 surfactant was added to the base matrixes composed by NL and NL/liquid rubber mixtures, and each ink was mixed in the high-speed mixer with ceramic beads at 2500 rpm for 30 s. To facilitate the vulcanization of the inks after printing, 2 phr of sulfur and 1 phr of stearic acid were added, and each ink mixture was again blended in the high-speed mixer at 2500 rpm for 30 s. Next, 4 phr of zinc oxide, 1 phr of TMTD, and 4 phr of CBTS were added, and each mixture was blended again at 2500 rpm for 30 s. Each ink mixture was then filtered through a mesh with a pore diameter of 140 μm to remove large agglomerates.

The setup for the customized direct printing (DP) system used included a dispensing system (pressure controller, syringes, and their holders) and motorized xyz-stage. A precision position control of the syringe tip was enabled by a PRO115 high-resolution XYZ linear stage (Aerotech, Inc.). ThorLabs model XR35C/M manual translation stages were installed on the Z-stage to calibrate the gap distance between the substrate and the dispensing tips. Extrusion through the syringe was accomplished through the application of pressure by an Ultimus™ I pneumatic pump (Nordson EFD). The XYZ linear stages and pressure controller were synchronized using G-code instructions and were interfaced with LabVIEW software (National Instruments).

A file in stereolithography (STL) format was prepared from a 3D model designed using SolidWorks® computer-aided design (CAD) software. Open-source software (Repetier-Host; Hot-World GmbH) was used to convert the STL file into layers and generate the G-code instructions that contained the toolpath and extrusion parameters needed for 3D printing. The layer thickness for the print was adjusted based on a tip size of 250 μm. A 100% infill density and a 45°/45° raster angle were used for the print settings. Each rubber ink was loaded into an Optimum® syringe barrel (Nordson EFD) immediately after preparation to prevent drying, then re-mixed using a high-speed mixer for 30 s at 2500 rpm to remove any air bubbles in the material. Next, the syringe was placed on the XYZ stage and connected to the pneumatic pump for 3D printing. Various pressure and speed ranges were investigated to optimize the printing parameters for the four inks.

In order to obtain the appropriate printing parameters for the four rubber inks, a printability test was conducted by operating the DP system using various printing pressures and speeds to print ink materials. The inks were continuously printed for a length of 150 mm in the positive Y-direction and 150 mm in the negative Y-direction, with a distance of 10 mm between lines (along the X direction). The gap height between the nozzle tip and substrate was set at 225 μm, which is 90% of the nozzle diameter. To enable the line width at the same location to be measured consistently, four parallel lines were drawn in the X-direction (against the printing direction) on a piece of paper, and the paper was attached to the bottom of the glass substrate so that the drawn lines would be visible in the background. The four parallel lines were drawn on the paper intersected with the two lines printed in the Y-direction, creating four intersection points in each direction (for a total of eight points on the two printed lines). This enabled the line width measurements for each ink to be conducted at the same eight locations on the printed lines.

The 3D model of a cube structure (FIG. 2) was used for accuracy tests, which was designed as a 1 cm³ unicube using SolidWorks®, and was printed using a 250-μm nozzle tip with 100% infill density. Five cube specimens for each ink were printed for testing. FIG. 2 demonstrates the XYZ direction of the cube. The dimensions of each green part were measured using low force calipers. The average volume changes for BN-0, BN-1, BN-2, and BN-3 were −12.49%, −7.52%, −5.47%, and −4.69%, respectively. The volume of the printed part was lower following vulcanization. The results showed that the average change in volume was smaller when the solid content in the ink was increased.

Different 3D structures were fabricated by the DP process to demonstrate the capabilities of the prepared rubber ink. The structures were built using ink BN-3 (the composite rubber ink with the highest solid content) using the printing parameters obtained from the printability test discussed above. One of the 3D structures was a tire tread (FIG. 1) as rubber applications would include tire tread, where tread materials used for commercial tires have a tensile stress of about 16 to 19 MPa and elongation at the break of about 280 to 580%.

### Example 2

In one example, liquid SBR (L-SBR) random copolymer rubber and liquid butadiene rubber (LBR) were obtained from Kuraray Company, Ltd. (Tokyo, Japan). Fumed silica (Cab-O-Sil M-5) to improve the rheological properties of the ink was purchased from Cabot Corporation (Boston, MA), and stearic acid activator was purchased from Sigma-Aldrich (St. Louis, MO). The vulcanizing agents and additives used (sulfur, zinc oxide [ZnO], tetramethylthiuram disulfide [TMTD] and N-cyclohexyl-2-benzothioazole sulfenamide [CBTS]) were provided by Akrochem Corporation (Akron, OH).

The rubber ink was prepared by adding L-SBR and LBR to a container in a 3:2 ratio, mixing the two rubbers at 2,500 rpm in a high speed mixer for 40 seconds with 10 phr of fumed silica. To enable vulcanization, a mixture containing 4 phr of ZnO, 1 phr of stearic acid, 4 phr of N cyclohexyl-2-benzothioazole sulfenamide (CBTS), 1 phr of tetramethylthiuram disulfide (TMTD) and 2.5 phr sulfur was mixed to homogeneity.

The direct print setup included a pneumatic dispensing system (a pressure controller and dispensing syringes) and a motorized XYZ stage. Precision position control of the syringe tip was enabled by a PRO115 high resolution XYZ linear stage (Aerotech, Incorporated). ThorLabs model XR35C/M manual translation stages were installed on the Z stage for gap distance calibration between the substrate and the dispensing tips. Pneumatic dispensing was accomplished through the application of pressure by an Ultimus I pneumatic pump (Nordson EFD). To attain synchronized operation, the XYZ linear stages and pressure-controlled dispensing systems were controlled using Gcode instructions sent through LabView systems engineering software (National Instruments).

A 3D model was designed using SolidWorks computer aided design (CAD) software and exported in the stereolithography (.stl) file format. Open source slicing software (Repetier-Host from Hot-World GmbH) was used to generate the G-code instructions that contain the tool path and extrusion parameters needed for 3D printing. The layer thickness of 406 μm was adjusted based on the tip size. Infill density of 100% and a raster angle of 45°/45° were used for the print settings. The formulated ink was loaded into an Optimum syringe barrel (Nordson EFD) and re-mixed using a high speed mixer for 40 seconds at 2,500 rpm to remove any air bubbles in the material. Next, the syringe was placed on the XYZ stage and connected to the pneumatic pump for 3D printing. Various pressure and speed ranges were investigated to optimize the printing parameters for the ink.

A conventional rubber vulcanization technique that inserts sulfur crosslinks using heat treatment was adopted in this system by using the same additives as initiators, activators, crosslinking agents and accelerants. The high viscosity of the blended mixture enabled the additives (sulfur, stearic acid, zinc oxide, TMTD and CBTS) to diffuse homogenously. Vulcanization of the material was then achieved by thermal treatment of the sample at 140° C. to 160° C. for 20 minutes. After thermal treatment, the sample was left to cool to room temperature.

As with Example 1, the dimensions of a cube before and after vulcanization were compared. It was found that the average change in volume was about 5.89%.

### Example 3

In one example, Tecnoflon® TN Latex (fluroelastomer latex) was acquired from Solvay, Zinc Oxide was provided from Akrochem Corp, and Triethylenetetramine and Chromium(III) oxide were purchased Sigma Aldrich.

For the ink preparation, the fluroelastomer latex was a terpolymer latex which has 70% solids by weight content. To enhance the rheological properties of the latex for the use in additive manufacturing, an increase in solid content was achieved by usage of a centrifugal separator to increase solid content to 78-90%. The collected latex was formulated with addition of 2-10 per hundred rubber (phr) ZnO, 0.5-5 phr TETA and 2-5 phr Cr₂O₃ in a high-speed mixer at 2000-2500 rpm for a duration of 10-300 seconds. Additionally, various reinforcing and non-reinforcing fillers were also added to the increase the mechanical properties and various high temperature properties of the printed part.

A Direct Print Photopolymerization (DPP) machine was used in the additive manufacturing. This setup included high-resolution XYZ linear stages (PRO115 stages from Aerotech, Inc.). Manual translation stages (model XR35C/M, ThorLabs) were attached to the extruder/syringe barrels and connected to Z-stage. Extrusion through the syringe was obtained by integrating a pneumatic pump (Ultimus™ I, Nordson EFD). XYZ linear stages and the pressure controller were synchronized using G-code instructions and were interfaced with LabVIEW.

A 3D model was designed using CAD software (SolidWorks®) to print using the custom DPP machine and the design was then translated as an STL (stereolithography) file. A host software (Repetier-Host, Hot-World GmbH) converted the STL file into layers and generated G-code, which contained the toolpath and extrusion parameter, for 3D printing. The layer thickness was adjusted based on the tip size of 250 Infill density and raster angle for printing were 100% and 45°/45°, respectively. The mixture was loaded into a syringe barrel (Optimum® Syringe Barrel, Nordson EFD) immediately after preparing to prevent drying, then re-mixed using a high-speed mixer for 30 sec at 2500 rpm to remove air bubbles in the material. Next, the syringe was placed on the XYZ stage and connected to the pneumatic pump to 3D print. Various pressure and speed ranges were investigated to optimize the printing parameter for different inks.

The printing parameters were set to maintain uniformity in line width by varying pressure and speed of axis. For an ideal print, the various tip sizes were tested to maintain uniformity and it was found that varying the speed from 2-50 mm/s and pressure from 20-89 psi was appropriate.

The rubber ink was formulated for curing after the completion of printing. Vulcanization included thermal treatment at 85-140° C. for a span of 8-90 mins which produced a fully vulcanized 3D printed part.

In light of the foregoing, it should be appreciated that the present invention significantly advances the art by providing improved rubber ink formulations, such as for direct ink writing. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A composition for a direct ink writing process, the composition comprising
a polymeric component in latex form, where the latex includes greater than 75% solids content; and
additives adapted to provide the composition with capability of being utilized as a rubber ink formulation for the direct ink writing process.

2. The composition of claim 1, where the latex includes greater than 90% solids content.

3. The composition of claim 1, where the polymeric component includes natural rubber.

4. The composition of claim 1, where the polymeric component includes synthetic rubber.

5. The composition of claim 1, where the polymeric component includes a fluorocarbon-based synthetic rubber.

6. The composition of claim 1, where the polymeric component includes natural rubber as a matrix in which a liquid synthetic rubber and the additives are dispersed.

7. The composition of claim 6, where a weight ratio of the natural rubber to the liquid synthetic rubber is greater than 5:1.

8. The composition of claim 1, where the polymeric component includes only liquid styrene-butadiene rubber and liquid butadiene rubber.

9. The composition of claim 1, where the polymeric component includes a synthetic rubber selected from butadiene rubber, isoprene rubber, styrene-butadiene rubber, butadiene copolymers, isoprene copolymer, silicon rubber, neoprene, nitrile type rubber, urethane rubber, chlorinated rubber, butyl rubber, acrylic rubber, fluoro rubber, isocyanate rubber, and combinations thereof.

10. The composition of claim 1, where the polymeric component includes a fluorocarbon-based synthetic rubber having a fluorine content of from about 60% to about 70%.

11. The composition of claim 10, where the polymeric component in latex form and including the fluorocarbon-based synthetic rubber includes less than 1 wt. % of solvent other than water.

12. The composition of claim 11, where the additives include chromium oxide as a pigment which is present in an amount of from about 2 parts per hundred parts rubber (phr) to about 5 phr.

13. The composition of claim 1, where the additives include a surfactant, a vulcanizing agent, an activator, an accelerator, and an inhibitor.

14. A tire component made from the composition of claim 1.

15. A sensor made from the composition of claim 1.

16. A method of producing an additive manufacturing product, the method comprising steps of
providing an initial polymeric component in latex form, where the initial polymeric component in latex form includes from about 50% to about 70% solids content;
removing water from the initial polymeric component in latex form to thereby form a subsequent polymeric component in latex form, where the subsequent polymeric component in latex form has greater than 75% solids content; and
mixing the subsequent polymeric component in latex form with additives adapted to provide a rubber ink formulation composition; and
additive manufacturing the rubber ink formulation composition to thereby form a green component.

17. The method of claim 16, where the additive manufacturing step is a direct ink writing step.

18. The method of claim 16, where the additives include a vulcanizing agent, the method further comprising a step of vulcanizing the green component to thereby form a vulcanized component.

19. The method of claim 18, where the vulcanized component is a tire tread.

20. The method of claim 18, where the vulcanized component is a sensor.
